(19) United States
(12) Patent Application Publication
(10) Pub. No.: US 2024/0175667 A1
(43) Pub. Date: May 30, 2024

(54) APPARATUS AND METHOD FOR ALIGNING A HANDLEBAR

(71) Applicant: Jochen KLIEBER, Tacherting (DE)

(72) Inventor: Jochen KLIEBER, Tacherting (DE)

(21) Appl. No.: 18/518,032

(22) Filed: Nov. 22, 2023

(30) Foreign Application Priority Data
Nov. 25, 2022 (DE) 102022131298.4

(51) Int. Cl. G01B 5/00; G01B 5/25

(52) U.S. Cl. CPC G01B 5/0025; G01B 5/25

(57) ABSTRACT

An apparatus for aligning a handlebar of a muscle-powered vehicle to a component of the muscle-powered vehicle includes an arrangement device for arranging the apparatus at two arrangement spots, which are spaced-apart to one another, at the handlebar, and a component pointer, which provides a positioning location for positioning the component pointer at the component. The positioning location is substantially equally spaced-apart from the two arrangement spots in a state of the apparatus arranged at the handlebar. A method for aligning a handlebar of a muscle-powered vehicle to a component of the muscle-powered vehicle by means of the apparatus is also disclosed.

### CROSS-REFERENCE TO RELATED APPLICATION

This application claims priority to German application DE 102022131298.4, filed Nov. 25, 2022, which is hereby incorporated by reference in its entirety.

### FIELD OF THE INVENTION

The present invention relates to an apparatus and method for aligning a handlebar of a muscle-powered vehicle to a component of the muscle-powered vehicle. The present invention also relates to a muscle-powered vehicle.

### BACKGROUND OF THE INVENTION

In muscle-powered vehicles known from the prior art, it may be necessary to align a handlebar of the muscle-powered vehicle relative to a component of the muscle-powered vehicle, such as its front wheel. In this regard, it may be necessary to visually inspect the alignment of the handlebar relative to the component and to manually adjust based on such visual inspection.

### SUMMARY OF THE INVENTION

In one aspect, the present invention relates to an apparatus for aligning a handlebar of a muscle-powered vehicle to a component of the muscle-powered vehicle. Aligning the handlebar may be setting or adjusting the relative orientation of the handlebar with respect to the component. Aligning the handlebar may be symmetrically aligning the handlebar to the component. Aligning the handlebar may further be orthogonally aligning the handlebar to the component.

The muscle-powered vehicle may be a two-wheeled vehicle or a three-wheeled vehicle. The muscle-powered vehicle may also include an energy storage for providing energy to drive the muscle-powered vehicle. Thus, in addition to being a vehicle that can be propelled solely or predominantly by muscle power, the muscle-powered vehicle can also be a vehicle that can be propelled in addition to muscle power by energy, which can be provided by an energy storage. The muscle-powered vehicle can therefore also be an e-bike, for example. The muscle-powered vehicle may be, for example, a two-wheeled bicycle or a three-wheeled bicycle. The handlebar may therefore be a two-wheeled vehicle handlebar, a three-wheeled vehicle handlebar, or a bicycle handlebar. The component of the muscle-powered vehicle may be a component deflectable with the handlebar or a frame-side component. The handlebar may be aligned to at least one of these components. Thus, the handlebar may also be aligned to different components, for example, the deflectable component and the frame-side component.

The apparatus comprises an arrangement device for arranging the apparatus at two arrangement spots, which are spaced-apart to one another, at the handlebar. The arrangement device may be configured for movably arranging the apparatus at the two arrangement spots. The two arrangement spots may be arrangement spots arranged symmetrically with respect to a handlebar center of the handlebar at the handlebar. According to one embodiment, the two arrangement spots are the two handlebar ends of the handlebar.

The apparatus further comprises a component pointer, which provides a positioning location for positioning the component pointer at the component. The positioning may be a centrical positioning of the component pointer at the component. The component pointer may be spaced-apart from the arrangement device. The positioning location may be spaced-apart from the arrangement device. The positioning location, in a state of the apparatus arranged at the handlebar, is substantially equally spaced-apart from the two arrangement spots. It is considered “substantially equally spaced-apart” if the distances between the positioning location and the two arrangement spots differ due to manufacturing tolerances of the apparatus or due to material properties of the apparatus, in particular in the state of the apparatus arranged at the handlebar, due to manufacturing or use.

According to one embodiment, the positioning location, in the state of the apparatus arranged at the handlebar, may be equally spaced-apart from the two arrangement spots. It is also considered “equally spaced-apart” if the distances between the positioning location and the two arrangement spots differ due to manufacturing tolerances of the apparatus or due to material properties of the apparatus, in particular in the state of the apparatus arranged at the handlebar, due to manufacturing or use. Manufacturing tolerances may relate to the manufacturing of the arrangement device, the component pointer, and a connection of the component pointer with the arrangement device.

The two arrangement spots and the positioning location, in the state of the apparatus arranged at the handlebar, may span an isosceles triangle. If the two arrangement spots are arranged symmetrically with respect to the handlebar center of the handlebar, the handlebar can be aligned symmetrically with respect to the component by positioning of the component pointer at the component.

According to an embodiment of the apparatus, the arrangement device may be configured for pivotally arranging the apparatus at the two arrangement spots. The arrangement device, in the state of the apparatus arranged at the handlebar, may be pivotable about a pivot axis which extends through the two arrangement spots or runs parallel to the two arrangement spots. The component pointer, in the arranged state of the apparatus, may be pivotable to the component. Alternatively or additionally, the component pointer, in the arranged state of the apparatus, may be pivotable to another component of the muscle-powered vehicle. The component pointer may therefore be pivotable to the deflectable component, for example a front wheel of the muscle-powered vehicle, and to the frame-side component, for example a top tube of the frame of the muscle-powered vehicle or a saddle of the muscle-powered vehicle. The positioning location can therefore be provided by the apparatus efficiently and with positional accuracy at at least one component of the muscle-powered vehicle, or at a plurality of components of the muscle-powered vehicle, to align the handlebar at the at least one component or the plurality of components.

According to another embodiment of the apparatus, the apparatus may be configured for aligning the handlebar to two different components of the muscle-powered vehicle. The two different components may be the deflectable component and the frame-side component, such as the front wheel and the top tube or the saddle. The component pointer may provide at least one positioning location for positioning the component pointer at the two components. The component pointer may provide two positioning locations for positioning the component pointer at the two components. The at least one positioning location or the two positioning locations, in the state of the apparatus arranged at the handlebar, may be substantially equally spaced-apart from the two arrangement spots. The apparatus may therefore be a multifunctional apparatus for aligning the handlebar to two different components of the muscle-powered vehicle, which may be mounted at the muscle-powered vehicle spaced-apart from each other.

According to another embodiment of the apparatus, the arrangement device may be configured for arranging the apparatus at the two handlebar end sections of the handlebar. The arrangement device may be a clasp-like device for respectively arranging the apparatus at the two handlebar end sections. The arrangement device may therefore be configured for symmetrically arranging the apparatus with respect to a handlebar center of the handlebar. The arrangement device may be configured for arranging the apparatus at different handlebars with different handlebar geometries. The arrangement device may also further be configured for arranging the apparatus at the two handles of the handlebar, which may be arranged at the handlebar ends.

According to a further embodiment of the apparatus, the arrangement device may comprise two arrangement elements, each of which comprises a funnel-shaped receptacle for symmetrically receiving the two handlebar end sections. The handlebar end sections may each comprise a handle. The funnel-shaped receptacles can have a respective conical recess in which a respective handlebar end section can be centrically received. The handlebar end sections can thus be received in the funnel-shaped receptacles in a pivotable manner about the arrangement spots.

According to a further embodiment of the apparatus, it can comprise two legs which are connected at a respective leg end via a rotating joint. The component pointer may provide the positioning location on an axis of rotation of the rotating joint. The arrangement device may be arranged at the two legs. The two arrangement elements may each be arranged at one of the two legs. The arrangement elements may be arranged at the ends of the legs opposite to the ends of the legs connecting the rotary joint. The rotating joint may be a hinge. The arrangement device may therefore be configured for variably arranging the apparatus at two arrangement spots, which are spaced-apart to one another, at the handlebar, wherein the distance between the two arrangement spots may be adjustable. An opening angle of the legs at the rotating joint may be adjustable to adjust the two arrangement spots. In addition, the rotatably connected legs, in a state where the apparatus is not arranged at the handlebar, may provide compact dimensions of the apparatus.

According to another embodiment of the apparatus, the two legs are connected to a tensioning mechanism. The tensioning mechanism, in the state of the apparatus arranged at the handlebar, can cause the apparatus to be tensioned at the handlebar via the arrangement device. The arrangement device can thus be arranged at the handlebar in a positionally accurate manner and pivotable about the pivot axis. During positioning of the component pointer at the component, it is therefore not necessary to manually hold the arrangement device at the handlebar.

According to a further embodiment of the apparatus, the component pointer comprises a mandrel, the mandrel tip of which provides the positioning location. With the mandrel, the component pointer can be positioned centrically at a component center of the component. Alternatively or in addition to the mandrel, the component pointer can also comprise a notch whose center axis can provide the positioning location. Also with the notch, the component pointer can be positioned centrically at a component center of the component.

In another aspect, the present invention relates to a method for aligning a handlebar of a muscle-powered vehicle to a component of the muscle-powered vehicle by means of the apparatus according to the preceding aspect. Also, the method may be performed multifunctionally for aligning the handlebar to different components of the muscle-powered vehicle.

The method comprises, as a step, arranging the arranging device of the apparatus at two arranging spots, which are spaced-apart to one another, at the handlebar. The arranging of the apparatus may be performed as described with respect to the preceding aspect. The method comprises, as a further step, positioning the component pointer of the apparatus at the component. The positioning may also be performed as described with respect to the preceding aspect. By positioning the component pointer, the handlebar can be aligned. The method comprises, as a further step, adjusting a connection mechanism connecting the handlebar with the component. Alternatively or in addition to the positioning, the handlebar can be aligned by adjusting the connection mechanism. By adjusting the connection mechanism, positioning of the component pointer can also be performed, thereby aligning the handlebar.

According to an embodiment of the method, in the step of positioning, the component pointer can be positioned at a component, in particular a front wheel, of the muscle-powered vehicle that can be deflected with the handlebar. In the step of adjusting, a deflection-side connection mechanism can be adjusted, which is configured to non-rotatably connect the handlebar with a fork shaft of the muscle-powered vehicle. The deflection-side connection mechanism may be configured to align the handlebar to the fork shaft.

According to another embodiment of the method, in the step of positioning, the component pointer may be positioned at a frame-side component, in particular a top tube or a saddle, of the muscle-powered vehicle. In the step of adjusting, a frame-side connection mechanism may be adjusted, which connects a fork shaft of the muscle-powered vehicle with the frame-side component and is configured to adjust a relative deflection of the fork shaft to the frame-side component. The frame-side connection mechanism may be a mechanism for resetting the fork shaft when the handlebar is deflected to a neutral position of the handlebar. The neutral position may be a handlebar position that provides straight-ahead travel of the muscle-powered vehicle.

According to another embodiment of the method, the step of adjusting the deflection-side connection mechanism may be performed after the step of positioning the component pointer at the deflectable component for aligning the handlebar to the deflectable component. Subsequently, as further steps, the step of adjusting the frame-side connection mechanism and the step of positioning the component pointer at the frame-side component for aligning the handlebar to the frame-side component may be performed.

In another aspect, the present invention relates to a muscle-powered vehicle comprising a handlebar aligned to at least one component of the muscle-powered vehicle with the apparatus according to the corresponding preceding aspect or by the method according to the preceding aspect.

Embodiments of one aspect of the present invention may form corresponding embodiments of any of the further aspects of the present invention.

### BRIEF DESCRIPTION OF THE DRAWINGS

FIG. 1 shows an apparatus for aligning a handlebar according to one embodiment of the invention;

FIG. 2 shows the apparatus in a state arranged at a handlebar;

FIG. 3 shows an arrangement of the apparatus at the handlebar for aligning the handlebar to a component that can be deflected with the handlebar;

FIG. 4 shows another arrangement of the apparatus for aligning the handlebar to a frame-side component; and

FIG. 5 shows a flowchart with steps of a method for aligning a handlebar.

### DETAILED DESCRIPTION OF THE INVENTION

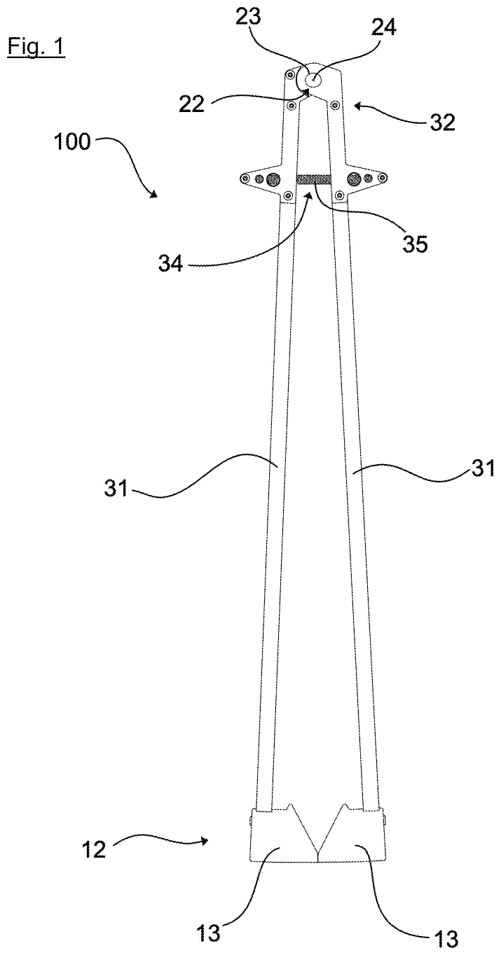

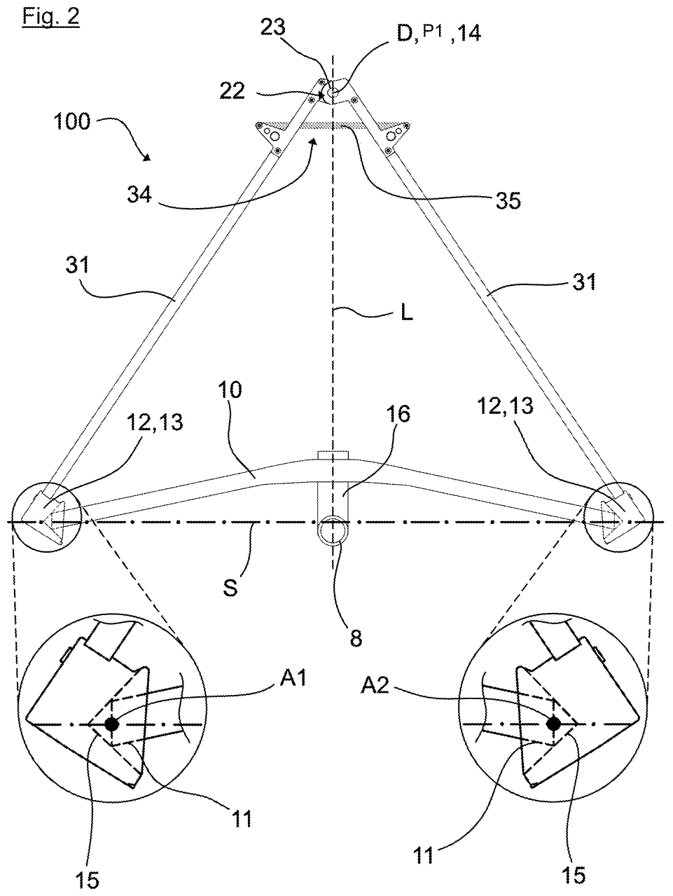

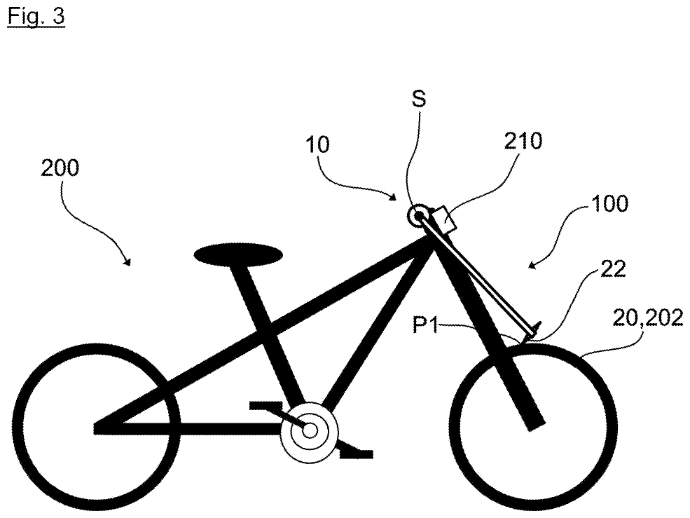

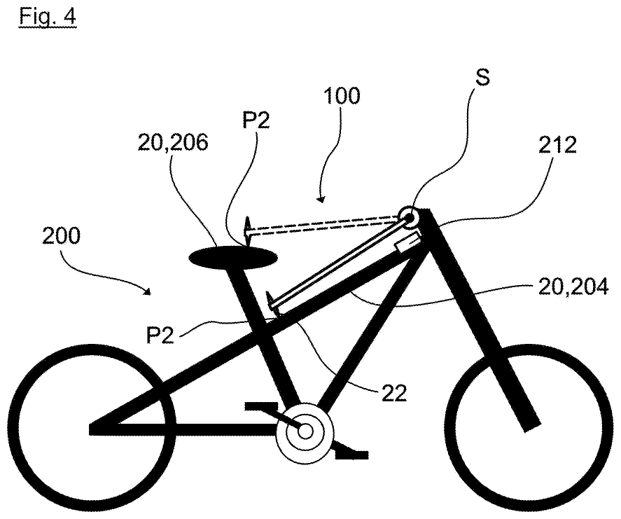

FIG. 1 shows an apparatus 100 for aligning a handlebar 10, shown in FIG. 2, of a muscle-powered vehicle 200, shown in FIGS. 3 and 4, to a component of the muscle-powered vehicle 200. The apparatus 100 comprises an arrangement device 12 with which the apparatus 100 can be arranged at the handlebar 10. The arrangement device 12 comprises two arrangement elements 13, with which the apparatus 100 can be arranged at the handlebar end sections of the handlebar 10. The arrangement device 12 can thus be arranged at handlebar end sections of the handlebar 10 via the two arrangement elements 13. The apparatus 100 further comprises a component pointer 22, which in the embodiment shown in FIG. 1 is formed as a mandrel 23. The mandrel 23 comprises a mandrel tip 24 that provides a positioning location for positioning the component pointer 22 at the component of the muscle-powered vehicle 200. The component pointer 22 is connected to the arrangement device 12. The apparatus 100 further comprises two legs 31 connecting the component pointer 22 to the two arrangement elements 13.

The apparatus 100 has a rotating joint 32 which pivotally connects the two legs 31. The component pointer 22 is arranged at the rotating joint 32. The rotating joint 32 thus connects the component pointer to the arrangement device 12, wherein the arrangement elements 13 being equally spaced-apart from the component pointer 22. The apparatus 100 also comprises a tensioning mechanism 34 that tensions the legs 31 to the collapsed state shown in FIG. 1. The tensioning mechanism 34 includes a tensioning spring 35 that connects the two legs 31 adjacent to the rotating joint 32. The spring ends of the tension spring 35 are attached to the legs 31, wherein the spring ends are attached externally to the leg axes.

FIG. 2 shows the apparatus 100 described with respect to FIG. 1 in a state arranged at the handlebar 10. The arrangement elements 13 are arranged at handlebar end sections 11 of the handlebar 10. The arrangement elements 13 comprise funnel-shaped receptacles 15 in which the handlebar ends 11 can be received symmetrically to the handlebar center of the handlebar 10. The apparatus 100 is thus arranged at two arrangement spots A1, A2, which are spaced-apart to one another, at the handlebar 10. A pivot axis S extends through the arrangement spots A1, A2, about which the apparatus 100 is arranged at the handlebar 10 in a pivotable manner. The component pointer 22 can thus be pivoted onto the component of the muscle-powered vehicle 200 to position the component pointer 22 centrically on the component. Such positioning and alignment of the handlebar 10 with respect to the component is made possible by the handlebar 10 being rotatably arranged with respect to a fork shaft 8 of the muscle-powered vehicle 200. In the embodiment shown in FIG. 2, the handlebar 10 further comprises a handlebar stem 16 rotatably mounted on the fork shaft 8. As shown in FIG. 2, the component pointer 22 is positioned on an axis of rotation D of the rotating joint 32 in a longitudinal plane L of the vehicle. Since the component is also positioned in the vehicle longitudinal plane L in a straight-ahead driving mode of the muscle-powered vehicle, the track of the muscle-powered vehicle 200 can thus be adjusted by aligning the handlebar 10.

FIG. 3 shows a muscle-powered vehicle 200, which in the embodiment shown in FIG. 3 is a bicycle. The apparatus 100 is arranged at the handlebar 10 of the muscle-powered vehicle 200 such that the apparatus 100 is pivotable about the pivot axis S. The apparatus 100 may be pivoted about the pivot axis S and the handlebar 10 may be aligned such that the component pointer 22 is positioned centrically on the component 20 at a positioning location P1, thereby the handlebar 10 is aligned symmetrically to the component 20. The component 20, in the embodiment shown in FIG. 3, is a front wheel 202 of the bicycle.

The alignability of the handlebar 10 is provided by a deflection side connection mechanism 210, which allows positioning of the component pointer 22 and aligning of the handlebar 10 to the component 20. The component 20 may be a deflection side component 20 of the muscle-powered vehicle 200. The deflection-side connection mechanism 210, in the embodiment shown in FIG. 3, may be a releasable clamping mechanism of the handlebar 10 with which the alignment of the handlebar 10 at the fork shaft 8 is adjustable and lockable. The releasable clamping mechanism may be provided by the handlebar stem 16, which adjustably and lockable connects the handlebar 10 with the fork shaft 8 on which the front wheel 202 is arranged.

FIG. 4 again shows the muscle-powered vehicle 200 already shown in FIG. 3. In the embodiment shown in FIG. 4, the apparatus 100 is pivoted about the pivot axis S and the handlebar 10 is aligned such that the component pointer 22 is positioned centrically on a further component 20 of the muscle-powered vehicle 200 at a further positioning location P2. The further component 20 may be a frame-side component 20 of the muscle-powered vehicle 200. The component 20 may be a top tube 204 or a saddle 206, the respective component center of which lies in the longitudinal plane L of the vehicle. The handlebar 10 may be aligned such that the component pointer 22 is positioned centrically on the further component 20, thereby aligning the handlebar 10 symmetrically with respect to the further component 20.

The alignability of the handlebar 10 is provided by a frame-side connection mechanism 212, which allows positioning the component pointer 22 and aligning the handlebar 10 to the further component 20. In the embodiment shown in FIG. 4, the frame-side connection mechanism 212 may include an adjustment mechanism of the handlebar 10, with which the alignment of the handlebar 10 to the further component 20 is adjustable. The alignment of the handlebar 10 may be a neutral position in which the handlebar 10 is not manually deflected. The frame-side connection mechanism 212 may provide a return of a deflected handlebar 10 into the neutral position.

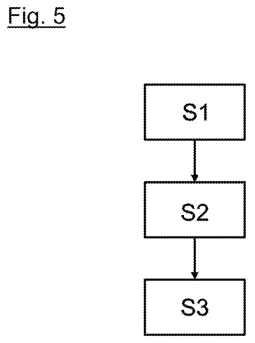

FIG. 5 shows a flowchart comprising steps S1 to S3 for performing a method for aligning the handlebar 10 relative to at least one of the described components 20. In a first step S1, the apparatus 100 is pivotally mounted at the handlebar 10 as described with respect to FIG. 2. In a second step S2, the component pointer 22 of the apparatus 100 is positioned at one of the components 20 to symmetrically align the handlebar 10 with respect to the component 20. In a third step S3, the connection mechanism connecting the handlebar 10 with the component 20 is adjusted to provide the symmetrical alignment of the handlebar 10. Steps S2 and S3 may be performed repetitively for the component 20 described with regard to FIG. 3 and for the further component 20 described with regard to FIG. 4.

In step S2, the component pointer 22 may first be positioned at the front wheel 202 before, in step S3, the deflection side connection mechanism 210 is adjusted to non-rotatably connect the handlebar 10 with a fork shaft 8. Further may the component pointer 22 subsequently, in a repeated step, be positioned at the top tube 204 or at the saddle 206 before, in step S3, the frame-side connection mechanism 212 is adjusted to align the handlebar 10 symmetrically with respect to the top tube 204 or the saddle 206. Thus, by repeated performance of steps S2 and S3, the handlebar 10 can be aligned symmetrically to both the front wheel 202 and the top tube 204 or the saddle 206, whereby the method may be used for adjusting the track of the muscle-powered vehicle 200.

### REFERENCE SIGNS

8 fork shaft
10 handlebar
11 handlebar end sections
12 arrangement device
13 arrangement elements
15 funnel-shaped receptacle
16 handlebar stem
20 component
22 component pointer
23 mandrel
24 mandrel tip
31 leg
32 rotating joint
34 tension mechanism
35 tension spring
100 apparatus
200 muscle-powered vehicle
202 front wheel
204 top tube
206 saddle
210 deflection side connection mechanism
212 frame side connection mechanism
A1, A2 arrangement spot
D axis of rotation
L vehicle longitudinal plane
P1, P2 positioning location
S pivot axis
S1 arranging
S2 positioning
S3 adjusting

1. An apparatus for aligning a handlebar of a muscle-powered vehicle to a component of the muscle-powered vehicle, comprising:
an arrangement device for arranging the apparatus at two arrangement spots, which are spaced-apart to one another, at the handlebar; and
a component pointer providing a positioning location for positioning the component pointer at the component;
wherein the positioning location, in a state of the apparatus arranged at the handlebar, is substantially equally spaced-apart from the two arrangement spots.

2. The apparatus according to claim 1, wherein:
the arrangement device is configured for pivotably arranging the apparatus at the two arrangement spots; and
the arrangement device, in the state of the apparatus arranged at the handlebar, is pivotable about a pivot axis which extends through the two arrangement spots or runs parallel to the two arrangement spots.

3. The apparatus according to claim 1, wherein:
the apparatus is configured for aligning the handlebar to two different components of the muscle-powered vehicle;
the component pointer provides at least one positioning location for positioning the component pointer at the two components; and
the at least one positioning location, in the state of the apparatus arranged at the handlebar, is substantially equally spaced-apart from the two arrangement spots.

4. The apparatus according to claim 1, wherein the arrangement device is configured for arranging the apparatus at two handlebar end sections of the handlebar.

5. The apparatus according to claim 4, wherein the arrangement device comprises two arrangement elements, each of which comprises a funnel-shaped receptacle for centrically receiving one of the two handlebar end sections.

6. The apparatus according to claim 1, further comprising:
two legs which are connected via a rotating joint;
wherein the component pointer provides the positioning location on an axis of rotation of the rotating joint; and
wherein the arrangement device is arranged at the two legs.

7. The apparatus according to claim 6, wherein the two legs are connected with a tensioning mechanism which, in the state of the apparatus arranged at the handlebar, causes the apparatus to be tensioned at the handlebar via the arrangement device.

8. The apparatus according to claim 1, wherein the component pointer comprises a mandrel, and a mandrel tip of the mandrel provides the positioning location.

9. A method for aligning a handlebar of a muscle-powered vehicle to a component of the muscle-powered vehicle by means of the apparatus according to claim 1 and comprising the steps:
arranging the arranging device of the apparatus at two arranging spots, which are spaced-apart to one another, at the handlebar;
positioning the component pointer of the apparatus at the component; and
adjusting a connection mechanism connecting the handlebar with the component.

10. The method according to claim 9, wherein:
in the step of positioning the component pointer is positioned at a deflectable component of the muscle-powered vehicle; and
in the step of adjusting, a deflection-side connection mechanism is adjusted, which is configured to non-rotatably connect the handlebar with a fork shaft of the muscle-powered vehicle.

11. The method according to claim 10, wherein the deflectable component of the muscle-powered vehicle is a front wheel.

12. The method according to claim 9, wherein:
in the step of positioning the component pointer is positioned at a frame-side component of the muscle-powered vehicle; and
in the step of adjusting, a frame-side connection mechanism is adjusted, which connects a fork shaft of the muscle-powered vehicle with the frame-side component and is configured to adjust a relative deflection of the fork shaft to the frame-side component.

13. The method according to claim 12, wherein the frame-side component of the muscle-powered vehicle is a top tube or a saddle.

14. The method according to claim 10, wherein:
wherein the step of adjusting is performed after the step of positioning for aligning the handlebar to the deflectable component; and
subsequently, as further steps
in the step of positioning the component pointer is positioned at a frame-side component of the muscle-powered vehicle; and then
in a further step of adjusting, a frame-side connection mechanism is adjusted, which connects a fork shaft of the muscle-powered vehicle with the frame-side component and is configured to adjust a relative deflection of the fork shaft to the frame-side component.
